(19) United States
(12) Patent Application Publication
(10) Pub. No.: US 2008/0066594 A1
(43) Pub. Date: Mar. 20, 2008

(54) Punch roller bypass unit

(75) Inventor: Daniel R. Anguiano, Monument, CO (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company.

(21) Appl. No.: 11/522,281

(22) Filed: Sep. 15, 2006

(51) Int. Cl. B26D 1/00

(52) U.S. Cl. 83/13; 83/304

(57) ABSTRACT

A punch roller bypass unit is disclosed. An illustrative embodiment of the punch roller bypass unit includes a unit frame having a pair of spaced-apart tracks, a first roller carried by the tracks and a second roller carried by the tracks in positionally adjustable relationship with respect to the first roller. A method of bypassing a paper web around a punch roller in a punching unit of a paper processing system is also disclosed.

### FIELD OF THE INVENTION

The present invention relates to paper processing systems. More particularly, the present invention relates to a punch roller bypass unit which enables a paper web to bypass a punch roller in a paper processing system while maintaining proper positioning and tensioning of the paper web.

### BACKGROUND OF THE INVENTION

In a paper chart production process, a “print on demand” production system is typically used to perform small batch, custom-printing jobs. The production system includes a paper processing system in which a reel or web of paper is initially loaded and run through multiple machines, each of which adds a step to the overall production process. Throughout the process, it is important to maintain proper indexing and tensioning of the paper web to avoid paper jams and other quality issues.

One of the steps in the production process frequently involves the punching of holes in the paper web and making the appropriate initial cuts for rounded corners on sheets of paper which are eventually cut from the paper web. The punching unit which carries out this process utilizes an electronic indexing eye that monitors and aligns operations to the printing process. The punching unit also includes a paper tensioner which maintains proper tension on the paper web.

In some processing applications, it is desired to avoid the punching of holes and rounding of corners in sheets of paper which are to be cut from the paper web. Therefore, the paper web must be re-routed to bypass the punching unit, which carries out these steps. Conventionally, this is carried out by hanging large rollers above the punching unit and re-routing the paper web above the punching unit on the rollers. However, this hanging method does not allow for utilization of the electronic indexing eye which monitors and properly aligns the paper web to the process. Furthermore, the hanging method eliminates tensioning of the paper web. Additional drawbacks of the hanging method include long set-up time as well as potential safety issues and increased noise and potential for static discharge.

### SUMMARY OF THE INVENTION

The present invention is generally directed to a punch roller bypass unit. An illustrative embodiment of the punch roller bypass unit includes a unit frame having a pair of spaced-apart tracks, a first roller carried by the tracks and a second roller carried by the tracks in positionally adjustable relationship with respect to the first roller.

The present invention is also generally directed to a method of bypassing a paper web around a punch roller in a punching unit of a paper processing system. An illustrative embodiment of the method includes providing a punch roller bypass unit including a unit frame having a pair of spaced-apart tracks, a first roller carried by the tracks and a second roller carried by the tracks in spaced-apart relationship with respect to the first roller; positioning the punch roller bypass unit generally adjacent to the punch roller; and routing the paper web around the first roller and the second roller of the punch roller bypass unit.

### BRIEF DESCRIPTION OF THE DRAWINGS

The invention will now be described, by way of example, with reference to the accompanying drawings, in which:

FIG. 1 is a top view of an illustrative embodiment of the punch roller bypass unit.

FIG. 2 is a side view of an illustrative embodiment of the punch roller bypass unit.

FIG. 3 is a front view of an illustrative embodiment of the punch roller bypass unit.

FIG. 4 is a schematic view of a punching unit of a paper processing system, with the punch roller bypass unit mounted on the punching unit and more particularly illustrating bypassing of a paper web from a punch roller around the punch roller bypass unit.

### DETAILED DESCRIPTION OF THE INVENTION

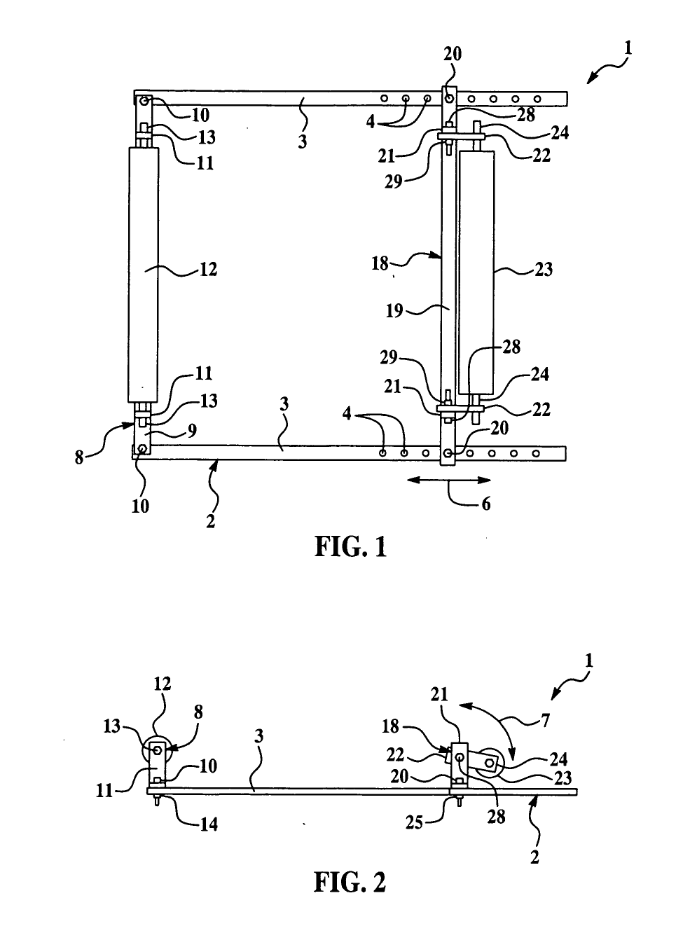

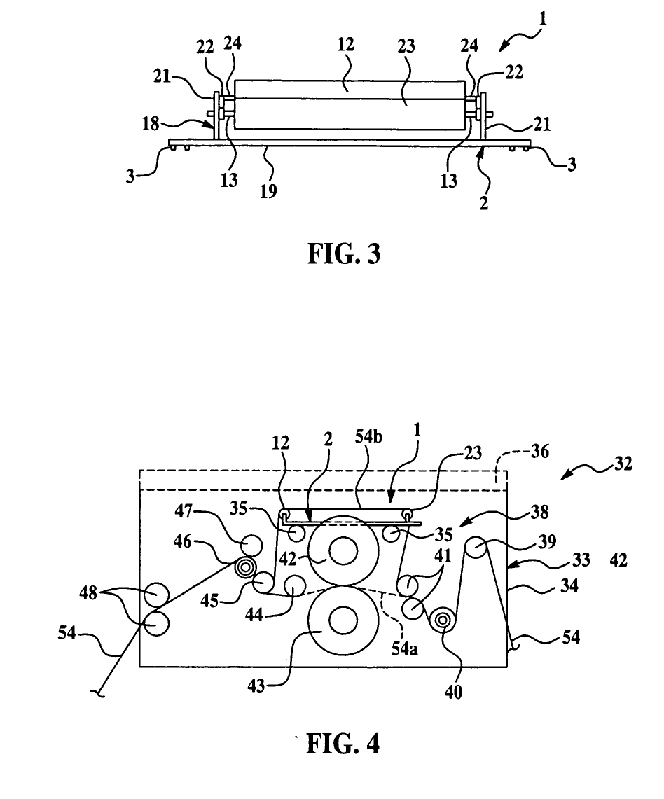

Referring initially to FIGS. 1-3, an illustrative embodiment of the punch roller bypass unit is generally indicated by reference numeral 1. The punch roller bypass unit 1 includes a unit frame 2 having a pair of spaced-apart, generally parallel tracks 3. Multiple roller adjustment openings 4 may extend through each track 3 for purposes which will be hereinafter described.

A fixed roller assembly 8 is provided on the unit frame 2. The fixed roller assembly 8 includes an elongated base member 9 which extends between the tracks 3, typically at one end of each track 3. The base member 9 may be attached to the tracks 3 using, for example, respective base member fasteners 10 each of which is secured by a nut 14, as shown in FIG. 2. A pair of roller mount flanges 11 extends from the base member 9, in spaced-apart relationship with respect to each other. An elongated, cylindrical fixed roller 12 is rotatably mounted between the roller mount flanges 11. For example, roller pins 13 typically extend from respective ends of the fixed roller 12 and extend through pin openings (not shown) provided in the respective roller mount flanges 11.

An adjustable roller assembly 18 is provided on the frame 2 and is positionally adjustable with respect to the fixed roller assembly 8. The adjustable roller assembly 18 includes an elongated base member 19. The base member 19 may be attached to the tracks 3 using, for example, base member fasteners 20 each of which extends through a fastener opening (not shown) provided in a corresponding end of the base member 19 and extends through a selected one of the spaced-apart roller adjustment openings 4 provided in the corresponding track 3. As shown in FIG. 2, a nut 25 is typically threaded on each base member fastener 20. The nut 25 may be a wing nut or other type of manually-rotatable nut to facilitate expeditious removal of the nut 25 from the corresponding base member fastener 20 and positional adjustment of the base member 19 along the tracks 3. It will be recognized and understood that the adjustable roller assembly 18 may be positionally adjustable along the tracks 3 using any suitable alternative mechanism known by those skilled in the art.

A pair of roller mount flanges 21 extends from the base member 19, in spaced-apart relationship with respect to each other. An adjustable roller plate 22 is provided on each roller mount flange 21. Each adjustable roller plate 22 is angularly adjustable with respect to the corresponding roller mount flange 21 according to the knowledge of those skilled in the art. For example, a roller plate fastener 28 may extend through registering fastener openings (not shown) provided in the roller mount flange 21 and adjustable roller plate 22, respectively. A nut 29 is threaded on the roller plate fastener 28. The nut 29 may be a wing nut or other type of manually-rotatable nut to facilitate expeditious angular adjustment of each adjustable roller plate 22 with respect to the corresponding roller mount flange 21. An adjustable roller 23 is rotatably mounted between the adjustable roller plates 22. For example, roller pins 24 typically extend from respective ends of the adjustable roller 23 and extend through pin openings (not shown) provided in the respective adjustable roller plates 22. Because the adjustable roller plates 22 are angularly adjustable with respect to the respective roller mount flanges 21, the adjustable roller 23 is pivotally adjustable with respect to the base member 19.

Referring next to FIG. 4, in typical application, the punch roller bypass unit 1 is placed in a punching unit 33 of a paper processing system 32. The paper processing system 32 is typically a “print on demand” production system which is used in a paper chart production process. The punching unit 33 of the paper processing system 32 may be a conventional paper-punching unit such as that which is obtainable from EMT International of Green Bay, Wis. The punching unit 33 typically includes a punching unit enclosure 34. Frame elements 35 are provided in the punching unit enclosure 34 for supporting and stabilizing the various interior components of the punching unit 33. A removable cover 36 (shown in phantom) is typically provided on the punching unit enclosure 34.

A punch roller assembly 38 is provided in the punching unit enclosure 34. The punch roller assembly 38 typically includes an entry roller 39, a first tensioning roller 40 spaced-apart with respect to the entry roller 39, a pair of adjacent guide rollers 41 spaced-apart with respect to the first tensioning roller 40, a punch roller 42 and an adjacent die roller 43 spaced-apart with respect to the guide rollers 41, a first guide roller 44 spaced-apart with respect to the punch roller 42 and the die roller 43, a second guide roller 45 spaced-apart with respect to the first guide roller 44, a second tensioning roller 46 adjacent to the second guide roller 45, a pressure roller 47 adjacent to the second tensioning roller 46 and a pair of adjacent exit rollers 48 spaced-apart with respect to the tensioning roller 46.

In typical operation of the paper processing system 32, a paper web 54 is typically subjected to various processing steps prior to being routed through the punching unit 33. The cover 36 is typically closed on the punching unit enclosure 34 during processing of the paper web 54. The paper web 54 enters the enclosure 34 and extends around the entry roller 39, the first tensioning roller 40 and between the guide rollers 41, respectively. In applications in which it is desired to punch holes and cut corners in sheets of paper (not shown) which will eventually be cut from the paper web 54, the paper web 54 is advanced from between the guide rollers 41, between the punch roller 42 and the die roller 43 and against the first guide roller 44 and the second guide roller 45, respectively, as indicated in phantom lines by the punching path 54a of the paper web 54. From the second guide roller 45, the paper web 54 is advanced between the second tensioning roller 46 and the pressure roller 47 and finally, between the exit rollers 48, from which the paper web 54 exits the punching unit enclosure 34. Throughout travel of the paper web 54 through the punch roller assembly 38, the first tensioning roller 40 and second tensioning roller 46 maintain tension on the paper web 54 for proper processing. Furthermore, an electronic indexing eye (not shown) provided in the punching unit enclosure 34 maintains the paper web 54 in proper position as it traverses the various rollers of the punch roller assembly 38.

In applications in which it is not desired to punch holes and cut corners in sheets of paper which will eventually be cut from the paper web 54, the punch roller bypass unit 1 is placed in the punching unit enclosure 34, generally above or adjacent to the punch roller 42. The unit frame 2 of the punch roller bypass unit 1 are typically attached to the frame elements 35 which extend on respective sides of the punch roller 42, using attachment brackets (not shown), attachment clips (not shown) or other techniques which are known to those skilled in the art. The paper web 54 is routed from between the guide rollers 41; around the adjustable roller 23 and the fixed roller 12, respectively, of the punch roller bypass unit 1; and then around the second guide roller 45 and between the second tensioning roller 46 and pressure roller 47, respectively, and finally, between the exit rollers 48 and out the punching unit enclosure 34.

It will be appreciated by those skilled in the art that the position of the adjustable roller assembly 18 with respect to the fixed roller assembly 8 can be selectively adjusted, as deemed necessary, by positionally adjusting the base member 19 of the adjustable roller assembly 18 along the tracks 3 of the unit frame 2, as indicated by the arrow 6 in FIG. 1. It will further be appreciated by those skilled in the art that the angular position of the adjustable roller 23 on the roller mount flanges 21 of the adjustable roller assembly 18 can be selectively adjusted, as deemed necessary, by adjusting the angular positions of the adjustable roller plates 22 on the respective roller mount flanges 21 of the adjustable roller assembly 18, as indicated by the arrow 7 in FIG. 2.

During operation of the punching unit 33, the paper web 54 bypasses the punch roller 42 and the die roller 43, as indicated in solid lines by the bypass path 54b in FIG. 4. Therefore, the holes and die cuts which are normally made in the paper web 54 as it traverses the punching path 54a are not made in the paper web 54 when it traverses the bypass path 54b. Processing of the paper web 54 continues at additional processing units (not shown) of the paper processing system 32 after the paper web 54 leaves the punching unit enclosure 34. During use of the punch roller bypass unit 1, the cover 36 can be closed on the punching unit enclosure 34. After use, the punch roller bypass unit 1 can be detached from the frame elements 35 and removed from the punching unit enclosure 34 and the paper web 54 re-routed between the punch roller 42 and the die roller 43, as indicated by the punching path 54a, to resume punching holes and making die cuts in the paper web 54. As it traverses the punching unit 33 along the bypass path 54b, the paper web 54 remains within the range of the electronic indexing eye (not shown) which monitors and maintains the proper position of the paper web 54 in the paper processing system 32. Furthermore, the necessary tension remains on the paper web 54 to prevent paper jams and other adverse quality issues.

Although this invention has been described with respect to certain exemplary embodiments, it is to be understood that the specific embodiments are for purposes of illustration and not limitation, as other variations will occur to those of ordinary skill in the art.

What is claimed is:

1. A punch roller bypass unit, comprising:
a unit frame having a pair of spaced-apart tracks;
a first roller carried by said tracks; and
a second roller carried by said tracks in positionally adjustable relationship with respect to said first roller.

2. The punch roller bypass unit of claim 1 further comprising elongated first and second base members carried by said tracks and wherein said first roller is carried by said first base member and said second roller is carried by said second base member.

3. The punch roller bypass unit of claim 2 wherein said second roller is pivotally adjustable with respect to said second base member.

4. The punch roller bypass unit of claim 2 further comprising a first pair of spaced-apart roller mount flanges carried by said first base member and a second pair of roller mount flanges carried by said second base member, and wherein said first roller is carried by said first pair of spaced-apart roller mount flanges and said second roller is carried by said second pair of spaced-apart roller flanges.

5. The punch roller bypass unit of claim 4 further comprising a pair of roller pins extending from said first roller and rotatably carried by said first pair of apart spaced-roller flanges.

6. The punch roller bypass unit of claim 4 wherein said second roller is pivotally carried by said second pair of spaced-apart roller flanges.

7. The punch roller bypass unit of claim 1 further comprising a plurality of roller adjustment openings provided in each of said tracks and a pair of base member fasteners carried by said second base member and extending through a pair of said roller adjustment openings, respectively.

8. The punch roller bypass unit of claim 1 wherein said first roller and said second roller each has a generally elongated, cylindrical shape.

9. A punch roller bypass unit, comprising:
a unit frame having a pair of spaced-apart tracks;
first and second base members carried by said tracks;
a first pair of spaced-apart roller mount flanges carried by said first base member;
a first roller carried by said first pair of spaced-apart roller mount flanges;
a second pair of spaced-apart roller mount flanges carried by said second base member;
a pair of adjustable roller plates pivotally carried by said second pair of spaced-apart roller mount flanges, respectively; and
a second roller carried by said pair of adjustable roller plates.

10. The punch roller bypass unit of claim 9 further comprising a pair of roller pins carried by said first roller and rotatably carried by said first pair of spaced-apart roller mount flanges.

11. The punch roller bypass unit of claim 10 further comprising a second pair of roller pins carried by said second roller and rotatably carried by said pair of adjustable roller plates.

12. The punch roller bypass unit of claim 9 further comprising a plurality of roller adjustment openings provided in each of said tracks and a pair of base member fasteners carried by said second base member and extending through a pair of said roller adjustment openings, respectively.

13. The punch roller bypass unit of claim 9 wherein said first roller and said second roller each has a generally elongated, cylindrical shape.

14. A method of bypassing a paper web around a punch roller in a punching unit of a paper processing system, comprising:
providing a punch roller bypass unit including a unit frame having a pair of spaced-apart tracks, a first roller carried by said tracks and a second roller carried by said tracks in spaced-apart relationship with respect to said first roller;
positioning said punch roller bypass unit generally adjacent to said punch roller; and
routing said paper web around said first roller and said second roller of said punch roller bypass unit.

15. The method of claim 14 wherein said second roller is positionally adjustable with respect to said first roller.

16. The method of claim 14 further comprising elongated first and second base members carried by said tracks and wherein said first roller is carried by said first base member and said second roller is carried by said second base member.

17. The method of claim 16 wherein said second roller is pivotally adjustable with respect to said second base member.

18. The method of claim 16 further comprising a first pair of spaced-apart roller mount flanges carried by said first base member and a second pair of roller mount flanges carried by said second base member, and wherein said first roller is carried by said first pair of spaced-apart roller mount flanges and said second roller is carried by said second pair of spaced-apart roller flanges.

19. The method of claim 18 further comprising a pair of roller pins carried by said first roller and rotatably carried by said first pair of spaced-apart roller mount flanges.

20. The method of claim 18 further comprising a pair of adjustable roller plates pivotally carried by said second pair of spaced-apart roller mount flanges, respectively, and wherein said adjustable roller is carried by said pair of adjustable roller plates.
